(19) United States
(12) Patent Application Publication
(10) Pub. No.: US 2019/0084236 A1
(43) Pub. Date: Mar. 21, 2019

(54) GUARD FOR OVERSIZED PARTICLES

(71) Applicant: HEWLETT-PACKARD DEVELOPMENT COMPANY, L.P., Houston, TX (US)

(72) Inventors: Andreu Oliver, Sant Cugat del Valles (ES); Josep Ferreiro, Sant Cugat del Valles (ES); Marc Nicolau, Sant Cugat del Valles (ES)

(73) Assignee: HEWLETT-PACKARD DEVELOPMENT COMPANY, L.P., Houston, TX (US)

(21) Appl. No.: 16/093,935

(22) PCT Filed: May 10, 2017
(86) PCT No.: PCT/US2017/032025

§ 371 Date: Oct. 15, 2018

(30) Foreign Application Priority Data
May 12, 2016 (GB) 1608346.1

(51) Int. Cl. B29C 64/35; B29C 64/357; B29C 64/153

(52) U.S. Cl. CPC B29C 64/35; B33Y 10/00; B29C 64/153; B29C 64/357

(57) ABSTRACT

Example implementations relate to a guard positionable in a 3D printing system to limit a passing of oversized particles of material to downstream of the guard. As an example, a guard comprises a portion aligned with an axis, the axis being parallel to a direction of travel of particles. The guard also comprises a guard member to direct particles away from the axis.

### BACKGROUND

Manufacturing processes such as three-dimensional (3D) printing use a build material to additively produce a part. For example, a Selective Laser Sintering (SLS) 3D printer may incrementally build up a 3D object layer by layer using a laser to selectively melt a powder build material on a powder bed.

Post processing of 3D printed parts often involves separation of the printed parts from left over printing material in a 3D printing machine. The printed parts are separated from the left over material and the material is collected, leaving the printed parts.

### BRIEF DESCRIPTION OF THE DRAWINGS

FIG. 1A schematically illustrates an example of a three dimensional (3D) printing system;

FIG. 1B schematically illustrates the material management station of the example of FIG. 1A;

FIG. 1C schematically illustrates a working area of the material management station of the example of FIG. 1B;

FIG. 2A schematically illustrates an internal circuit diagram of one example of a material management station;

FIG. 2B is a table schematically illustrating valve setting information for the material management station internal circuit of FIG. 2A; and

FIG. 2C a build material trap geometry used in tanks of the material management station internal circuit of FIG. 2A.

FIG. 3A schematically illustrates one example of a guard.

FIG. 3B shows an example method of use of a guard.

FIG. 4 shows another example of a guard.

FIG. 5 shows a further example of a guard.

FIG. 6A shows a still further example of a guard.

FIG. 6B shows a portion of the guard of FIG. 6A.

FIG. 6C shows a partial cutaway view of the portion of the guard of FIG. 6B.

FIG. 6D shows a partial cutaway view of a portion of the guard of FIG. 6A.

### DETAILED DESCRIPTION

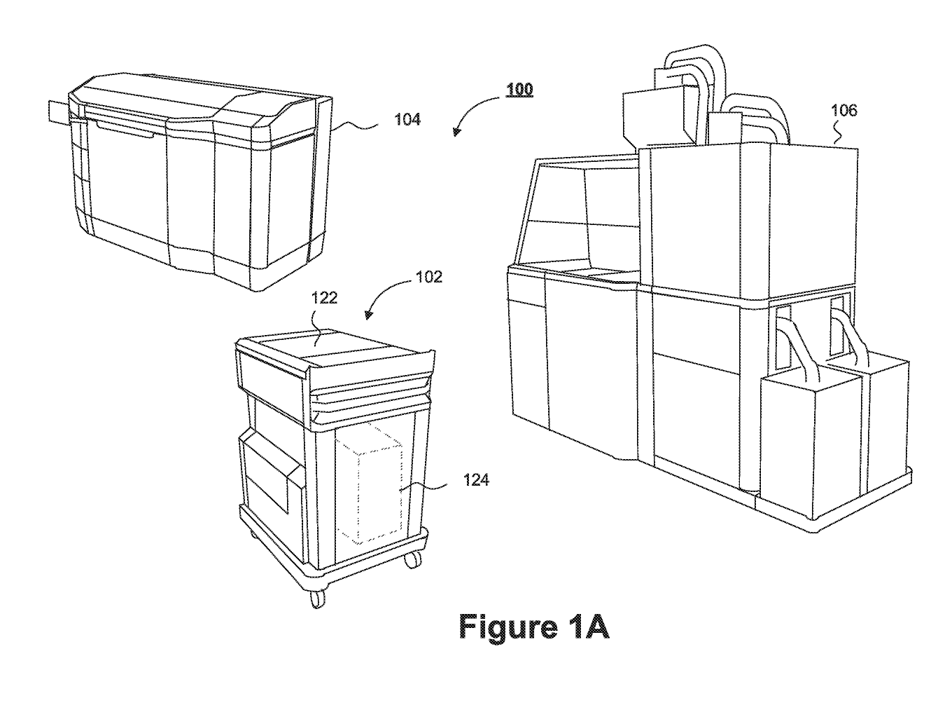

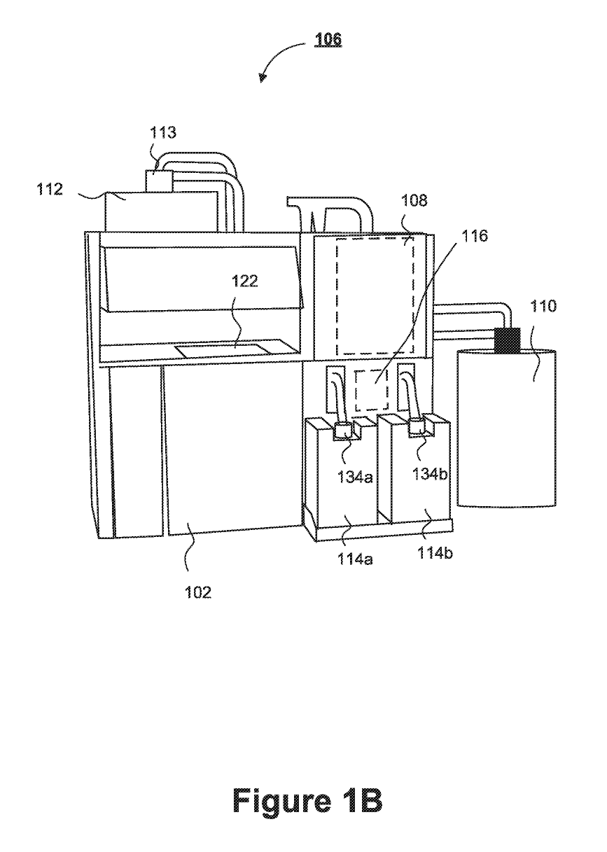

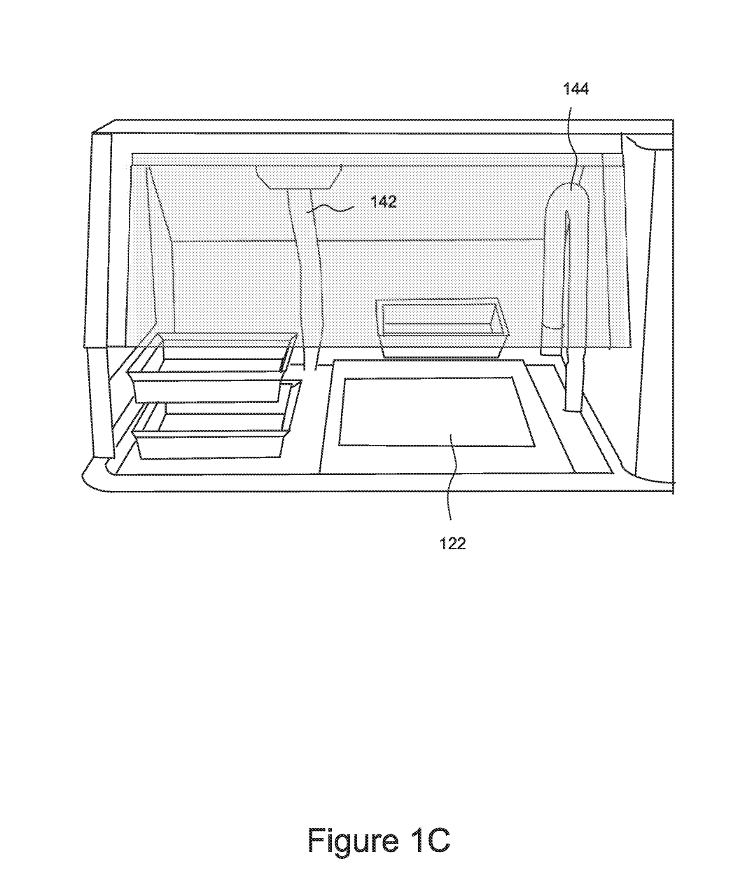

As shown in FIG. 1A, the three dimensional (3D) printing system 100 (or additive manufacturing system) according to one example comprises: a trolley 102, a 3D printer 104 and a material management station 106. The material management station 106 manages build material.

The trolley 102 is arranged to slot into a docking position in the printer 104 to allow the printer 104 to generate a 3D object within the trolley. The trolley is also arranged to also slot (at a different time) into a docking position 107 in the material management station 106. The trolley 102 may be docked in the material management station 106 prior to a 3D printing process to load the trolley with build material in preparation for a subsequent 3D printing process.

The build material loaded into the trolley may include recycled or recovered build material from one or more previous printing processes, fresh build material or a portion of fresh and recycled build material. Some build materials may be non-recyclable and hence in this case no recovered build material will be used to load the trolley. The build material may be or include, for example, powdered metal materials, powdered composited materials, powder ceramic materials, powdered glass materials, powdered resin material, powdered polymer materials and the like. In some examples where the build material is a powder-based build material, the term powder-based materials is intended to encompass both dry and wet powder-based materials, particulate materials and granular materials. It should be understood that the examples described herein are not limited to powder-based materials, and may be used, with suitable modification if appropriate, with other suitable build materials. In other examples, the build material may be in the form of pellets, or any other suitable form of build material, for instance.

Returning to FIG. 1A, the trolley 102 may also be docked in the docking position 107 in the material management station 106 (shown without the trolley 102 docked in FIG. 1A) to clean up at least some components of the trolley 102 after it has been used in a 3D printing production process. The clean-up process may involve recovery and storage in the material management station 106 of unfused build material from the previous print job for subsequent reuse. During a 3D printing process a portion of the supplied build material may be fused to form the 3D object, whilst a remaining portion of the supplied build material may remain unfused and potentially recyclable, depending upon the type of build material used. Some processing of the unfused build material may be performed by the material management station 106 prior to storage for recycling, to reduce any agglomeration for example.

It will be understood that the material management station 106 may also include an access panel (not shown) to cover the docking position 107 when the trolley 102 is fully docked with the material management station 106 and when the trolley 102 is fully removed from the material management station 106.

One material management station 106 can be used to service one or more different 3D printers. A given 3D printer may interchangeably use one or more trolleys 102, for example, utilising different trolleys for different build materials. The material management station 106 can purge a trolley 102 of a given build material after a 3D printing production process, allowing it to be filled with a different build material for a subsequent 3D printing production run. Purging of the trolley 102 may also involve purging of the material management station 106 or alternatively, it may involve separation of different build materials in the material management station 106 to limit contamination of one build material type with another.

The trolley 102 in this example has a build platform 122 on which an object being manufactured is constructed. The trolley 102 also comprises a build material store 124 situated beneath a build platform 122 in this example. The build platform 122 may be arranged to have an actuation mechanism (not shown) allowing it, when it is docked in the printer 104 and during a 3D printing production process, to gradually move down, such as in a step-wise manner, towards the base of the trolley 102 as the printing of the 3D object progresses and as the build material store 124 within the trolley 102 becomes depleted. This provides progressively more distance between the base level of the build platform 122 and the print carriages (not shown) to accommodate the 3D object being manufactured. The size of an object being printed may increase progressively as it is built up layer-by-layer in the 3D printing process in this example.

The 3D printer 104 of this example can generate a 3D object by using a build material depositor carriage (not shown) to form layers of build material onto the build platform 122. Certain regions of each deposited layer are fused by the printer 104 to progressively form the object according to object-specifying data. The object-specifying data are based on a 3D shape of the object and may also provide object property data such as strength or roughness corresponding to the whole object or part(s) of the 3D object. In examples, the desired 3D object properties may also be supplied to the 3D printer 104 via a user interface, via a software driver or via predetermined object property data stored in a memory.

After a layer of the build material has been deposited on the build platform 122 by the printer 104, a page-wide array of thermal (or piezo) printheads on a carriage (not shown) of the 3D printer 104 can traverse the build platform 122 to selectively deposit a fusing agent in a pattern based on where particles of the build material are to fuse together. Once the fusing agent has been applied, the layer of build material may be exposed to fusing energy using one or more heating elements (not shown) of the 3D printer 104. The build material deposition, fusing agent and fusing energy application process may be repeated in successive layers until a complete 3D object has been generated. The material management station 106 may be used with any additive manufacturing technique and is not limited to printers using printheads on a carriage to deposit a fusing agent as in the example described above. For example, the material management station 106 may be used with a selective laser sintering additive manufacturing technique.

FIG. 1B schematically illustrates the material management station 106 of the example of FIG. 1A, with the trolley 102 of FIG. 1A docked therein.

As shown in the example of FIG. 1B, the material management station 106 has two interfaces for receiving two fresh build material supply tanks (or cartridges) 114a, 114b, which may be releasably insertable in the material management station 106. In this example, each fresh build material supply tank 114a, 114b has a capacity of between about thirty and fifty litres. In one example, the build material may be a powdered semi-crystalline thermoplastic material. The provision of two fresh build material supply tanks 114a, 114b allows “hot swapping” to be performed such that if a currently active container becomes empty or close to empty of build material when the trolley 102 is being filled with build material by the material management station 106 in preparation for an additive manufacturing process, a fresh build material supply source can be dynamically changed to the other of the two tanks. The material management station 106 may have one or more weight measurement device(s) to assess how much fresh build material is present at a given time in one or more of the fresh build material supply tanks 114a, 114b. The fresh build material from the tanks 114a, 114b, may be consumed, for example, when loading the trolley 102 with build material prior to the trolley 102 being installed in the printer 104 for a 3D printing production run.

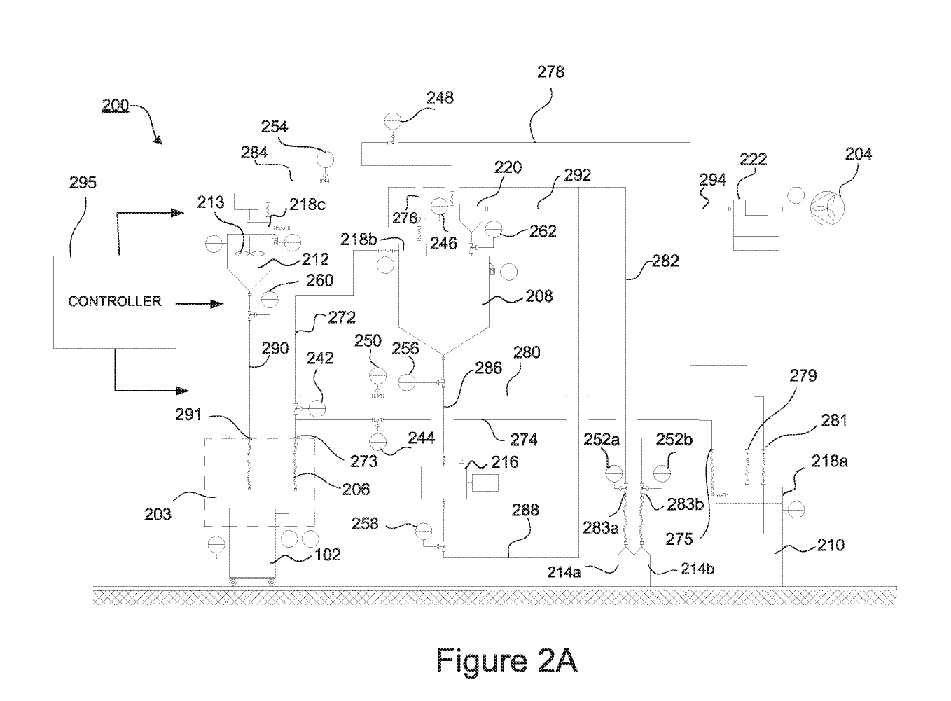

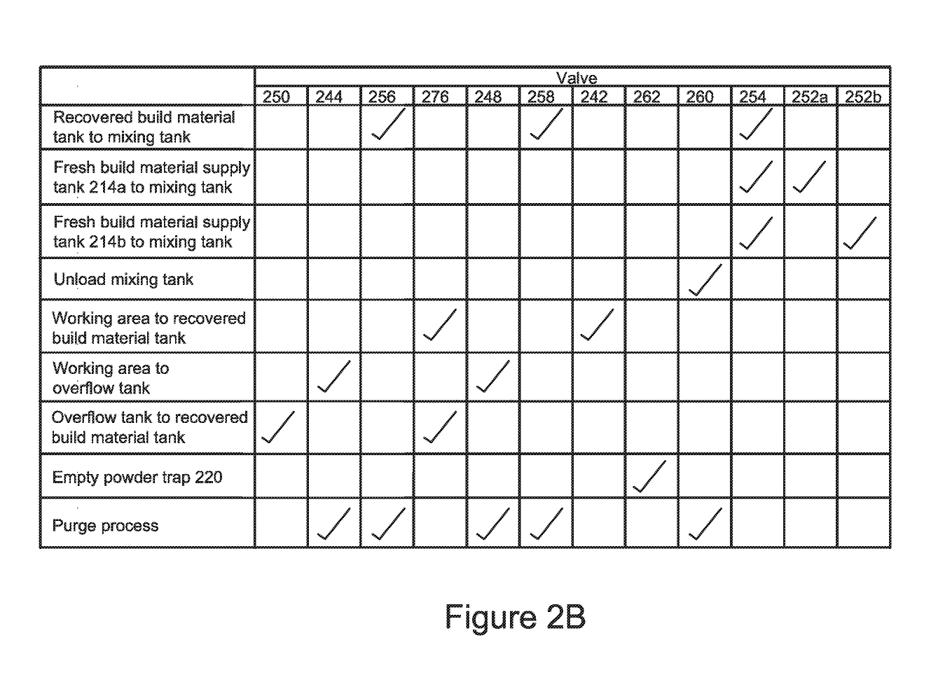

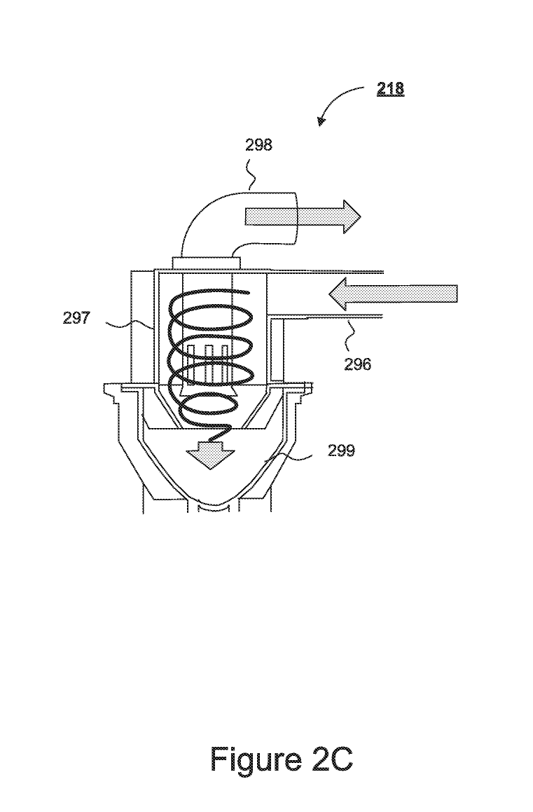

Build material is moved around within the material management station 106 in this example using a vacuum system (described below with reference to FIG. 2A), which promotes cleanliness within the system and allows for recycling of at least a portion of build material between successive 3D printing jobs, where the type of build material selected for use is recyclable. References to a vacuum system in this specification include a vacuum that is partial vacuum or a pressure that is reduced, for example, relative to atmospheric pressure. The vacuum may correspond to “negative pressure”, which can be used to denote pressures below atmospheric pressure in a circuit surrounded by atmospheric pressure.

A total trolley-use time for printing of a 3D object before trolley 102 can be reused may depend upon both a printing time of the printer 104 when the trolley 102 is in the printer 104 and a cooling time of the contents of the build volume of the trolley 102. It will be understood that the trolley 102 can be removed from the printer 104 after the printing operation, allowing the printer 104 to be re-used for a further printing operation using build material within a different trolley before the total trolley-use time has elapsed. The trolley 102 can be moved to the material management station 106 at the end of the printing time. The vacuum system can be used, in some examples, to promote more rapid cooling of the contents of the build volume following a 3D print production process than would otherwise occur without the vacuum system. Alternative examples to the vacuum system such as a compressed air system can create excess dust, potentially making the clean-up process more difficult.

The material management station 106 in this example has a recovered build material tank 108 (see FIG. 16), located internally, where build material recovered from the trolley 102 by the vacuum system is stored for subsequent reuse, if appropriate. Some build materials may be recyclable whilst others may be non-recyclable. In an initial 3D printing production cycle, 100% fresh build material may be used. However, on second and subsequent printing cycles, depending upon build material characteristics and user choice, the build material used for the print job may comprise a proportion of fresh build material (e.g. 20%) and a portion of recycled build material (e.g. 80%). Some users may elect to use mainly or exclusively fresh build material on second and subsequent printing cycles, for example, considering safeguarding a quality of the printed object. The internal recovered build material tank 108 may become full during a post-production clean-up process, although it may become full after two or more post-production clean up processes have been performed, but not before. Accordingly, an overflow tank in the form of an external overflow tank 110 can be provided as part of the material management station 106 to provide additional capacity for recovered build material for use once the internal recovered build material tank 108 is full or close to full capacity. Alternatively, the external overflow tank 110 can be a removable tank. In this example, one or more ports are provided as part of the material management station 106 to allow for output of or reception of build material to and/or from the external overflow tank 110. A sieve 116 or alternative build material refinement device may be provided for use together with the internal recovered build material tank 108 to make unfused build material recovered from a 3D printing production process for recycling more granular, that is, to reduce agglomeration (clumping).

The material management station 106 in this example has a mixing tank (or blending tank) 112 comprising a mixing blade (not shown) for mixing recycled build material from the internal recovered build material tank 108 with fresh build material from one of the fresh build material supply tanks 114a, 114b for supply to the trolley 102 when it is loaded prior to a printing production process. The mixing tank (or blending tank) 112, in this example, is provided on top of the material management station 106, above the location of the build platform 122 when the trolley 102 is docked therein. The mixing tank 112 is connected to a mixer build material trap 113 (described below with reference to FIG. 2A) for input of build material into the mixing tank 112.

The fresh build material supply tanks 114a, 114b, the external overflow tank 110 and the main body of the material management station 106 may be constructed to fit together in a modular way, permitting a number of alternative geometrical configurations for the fully assembled material management station 106. In this way, the material management station 106 is adaptable to fit into different housing spaces in a manufacturing environment.

is The fresh build material supply tanks 114a, 114b may be releasably connected to the main body of the material management station 106 via respective supply tank connectors 134a, 134b. These supply tank connectors 134a, 134b may incorporate a security system to reduce the likelihood of unsuitable build material being used in the 3D printing system. In one example, suitable fresh build material supply tanks 114a, 114b are provided with a secure memory chip, which can be read by a chip reader (not shown) or other processing circuitry on the main body of the material management station 106 to verify the authenticity of any replacement supply tank (cartridge) 114a, 114b that has been installed. In this example, the chip reader may be provided on the supply tank connectors 134a, 134b and upon attachment of the fresh build material supply tanks 114a, 114b to the respective connector 134a, 134b, an electrical connection may be formed. The processing circuitry in the material management station 106 may also be used to write a measured weight of build material determined to be in the respective fresh build material supply tank(s) 114a, 114b onto the secure memory chip of the tank to store and/or update that value. Thus, the amount of authorized build material remaining in the fresh build material supply tank(s) 114a, 114b at the end of a trolley loading process can be recorded. This allows the withdrawal of particulate build material from the fresh build material supply tanks 114a, 114b beyond the quantity with which it was filled by the manufacturer to be prevented. For example, in the case of a fresh build material supply tank 114a, 114b from which the tank manufacturer's authorised fresh build material has previously been completely withdrawn, this prevents the withdrawal of further build material that may damage the printer or print quality, if the fresh build material supply tank were re-filled with alternative fresh build material.

The secure memory chip of the fresh build material supply tanks 114a, 114b can store a material type of the build material contained within the fresh build material supply tanks. In one example, the material type is the material (e.g. ceramic, glass, resin, etc.). In this way, the material management station 106 can determine the material type to be used by the material management station 106.

FIG. 1C schematically illustrates a working area of the material management station 106 of the example of FIG. 1B, showing the build platform 122 of the trolley 102 and a build material loading hose 142, which provides a path between the mixing tank 112 of FIG. 1B and the build material store 124 of the trolley 102. The loading hose 142 is used for loading the trolley 102 with build material prior to the trolley 102 being used in the printer 104. FIG. 1C also shows a recycling hose 144 for unpacking manufactured 3D objects, cleaning the build platform 122 of the trolley 102 and a surrounding working area within the material management station 106. In one example, the recycling hose 144 operates by suction provided via a pump 204 (see FIG. 2A) and provides an enclosed path to the recovered build material tank 108 (see FIG. 1B) for receiving and holding build material for re-use in a subsequent 3D printing process. The recycling hose 144 may, in one example, be operated manually by a user to recover recyclable build material from and/or to clean up a working area of the material management station 106.

FIG. 2A schematically illustrates an internal circuit diagram 200 of one example of a build material management system in the form of a material management station 106. The material management station 106 can be used in conjunction with the trolley 102 of FIG. 1A.

As previously described, printed parts along with unfused build material can be transported from the 3D printer 104 to the material management station 106 via the trolley 102. The material management station 106 can then be used to process build material and printed parts from the trolley 102.

In another example, printed parts along with unfused build material can be transported from the 3D printer 104 to the material management station 106 via another suitable container, e.g. a box or cartridge (not shown) instead of the trolley 102. The material management station 106 may then be used to process the powder-based material and printed parts from the container.

The material management station circuit 200 includes a conduit (or guide-channel) network and a pump 204 to provide a pressure differential across the conduit network to transport unfused build material between different components, as described below with reference to FIG. 2A. In this example, the pump 204 is a suction pump which operates to create a pressure differential across the suction pump to produce air flow from an air inlet at substantially atmospheric pressure through the conduit network towards an upstream side of the suction pump (at a pressure below atmospheric pressure or at “negative pressure”). The pump 204 may be provided as an integral part of the material management station 106 in one example, but in another example, the material management station 106 provides a negative/reduced pressure interface, via which a suction pump may be detachably coupled or coupled in a fixed configuration. Although the description below refers to first conduit, second conduit, third conduit, etc. of the conduit network, there is no implied ordering in the number of the conduits other than to distinguish one conduit from another.

A collection hose 206 is connected to a recovered build material tank (RBMT) 208 via a working area port in a working area 203 in the form of a working area inlet port 273 and a first conduit (hose-to-RBMT conduit) 272 of the conduit network. The recovered build material tank 208 includes a recovered build material tank (RBMT) inlet area comprising a recovered build material tank (RBMT) build material trap 218b and a recovered build material tank (RBMT) material outlet. The RBMT inlet area is where a fluidised flow of build material is received for storage in the recovered build material tank 208. The first conduit 272 provides a path between the working area inlet port 273 and the RBMT inlet area. The working area inlet port 273 is to receive build material from the collection hose 206 and is provided at an end of the first conduit 272 connected to the collection hose 206. In other examples, the RBMT inlet area may communicate directly with the working area 203 or the collection hose 206 without a first conduit 272 between.

The recovered build material tank 208 in this example is provided internally to the material management station 106. A hose-to-RBMT valve 242 is positioned along the first conduit 272 for opening and closing the path through the first conduit 272. The collection hose 206 extends from the working area inlet port 273 into the working area 203. The working area 203 includes at least a portion of the trolley 102 (or other container) and can be maintained at substantially atmospheric pressure. Build material from the trolley 102 can be collected by the collection hose 206 and transported to the recovered build material tank 208 through the first conduit 272. The recovered build material tank 208 can be used for storing any unfused build material from the trolley 102 that is suitable for being used again in a further 3D printing (additive manufacturing) process. In this way, the recovered build material tank 208 can be used as a buffer storage tank to temporarily store unfused build material prior to supplying the unfused build material for use in a further 3D printing (additive manufacturing) process.

A second conduit 274 (hose-to-overflow conduit) of the conduit network connects the collection hose 206 to an overflow tank 210. The overflow tank 210 includes an overflow inlet area and the second conduit 274 provides a path between the collection hose 206 and the overflow inlet area comprising, in this example, an overflow build material trap 218a (a filter). An overflow tank port in the form of an overflow tank outlet port 275 may also be provided at an end of the second conduit 274. The overflow tank 210 can be selectively sealed by an openable lid (not shown). In a sealed configuration, the overflow tank 210 is in fluid communication with one or more overflow inlet ports and overflow outlet ports of the conduit network. Furthermore, in the sealed configuration, the overflow tank 210 is not directly open to the atmosphere. Build material from the working area 203 can be transported through the second conduit 274 and overflow tank outlet port 275 into the overflow tank 210. A hose-to-overflow valve 244 is positioned along the second conduit 274 for opening and closing a path through the second conduit 274. Unfused build material from the trolley 102 (or other container) can be collected by the collection hose 206 and transported to the overflow tank 210 through the first conduit 272. The overflow tank 210 is an external tank that is removable and that can be used for storing excess recoverable (recyclable) build material when the recovered build material tank 208 is full. Alternatively, the overflow tank 210 can be used as a waste storage tank to store unfused build material from the trolley 102 that is not suitable for recycling. In a further alternative, the overflow tank 210 can be used as a purged build material storage tank to store unfused build material from the trolley 102 and from elsewhere in the material management station 106 when the material management station 106 is purged of unfused build material.

The pump 204 is connected via a third conduit (pump-to-RBMT conduit) 276 of the conduit network to the recovered build material tank 208. The third conduit 276 provides a path between the pump 204 and the RBMT inlet area. A RBMT-to-pump valve 246 is positioned along the third conduit 276 for opening and closing the path through the third conduit 276.

The pump 204 is also connected to the overflow tank 210 via a fourth conduit (pump-to-overflow conduit) 278 of the conduit network. The fourth conduit 278 provides a path between the pump 204 and the overflow inlet area. An overflow tank port in the form of an overflow tank vacuum port 279 may also be provided at an end of the fourth conduit 278. Fluid, e.g. air, can transmit through the overflow tank vacuum port 279 from the overflow inlet area towards the pump 204. An overflow-to-pump valve 248 is positioned along the fourth conduit 278 for opening and closing a path through the fourth conduit 278.

Unfused build material in the trolley 102 can be collected using the collection hose 206 and transported either to the recovered build material tank 208 or to the overflow tank 210, or both. The tank to be used at a given time can be selected by opening appropriate valves along the conduits of the circuit of FIG. 2A.

The valves described herein with reference to FIG. 2A may be controlled by a controller 295, which may be, for example a programmable logic controller forming a part of processing circuitry of the build material management station 106. The controller 295 may electronically open one or more valves to open one or more paths in respective conduits based on the material transport operation being performed. The controller 295 may also electronically close one or more valves to close one or more paths in respective conduits. The valves may be, for example, butterfly valves and may be actuated using compressed air. In another example, one or more valves may be opened and closed manually by a user.

The controller controls the general operation of the material management system 200. The controller may be a microprocessor-based controller that is coupled to a memory (not shown), for example via a communications bus (not shown). The memory stores machine executable instructions. The controller 295 may execute the instructions and hence control operation of the build material management system 200 in accordance with those instructions.

FIG. 2B is a table schematically illustrating for each of a number of different build material source locations and build material destination locations, an appropriate valve configuration corresponding the valves as labelled in FIG. 2A. A tick in an appropriate column of the table indicates that the corresponding valve is controlled to be open by the controller 295 for the particular build material transport operation. For example, when transporting build material from the recovered build material tank 208 to the mixing tank 212, the valves 256,258 and 254 are set by the controller 295 to be open, whereas the valves 250, 244, 276, 248, 242, 262, 260, 252a and 252b are set to be closed. In alternative examples, some valves may be set to be open by simultaneity.

In an example, a recyclability indicator is determined by processing circuitry of the build material management station 106. The recyclability indicator can be indicative of whether the build material in the trolley 102 (or container) includes recyclable or recoverable material. When it is determined that the unfused build material in the trolley 102 is not recyclable or when the recovered build material tank 208 is full, the unfused build material can be transported to the overflow tank 210.

To transport the unfused build material from the trolley 102 (or container) to the overflow tank 210, the hose-to-overflow valve 244 in the second conduit 274 between the collection hose 206 and the overflow tank 210 and the overflow-to-pump valve 248 in the fourth conduit 278 between the pump 204 and the overflow tank 210 can be opened, e.g. electronically by the controller 295. When the pump is active, a differential pressure is provided from the pump to the collection hose 206. That is, a pressure at the pump 204 is lower than a pressure at the collection hose 206. The differential pressure enables build material from the trolley 102 (or container) to be transported to the overflow tank 210. Build material (and air) in proximity with an end of the collection hose 206 (at approximately atmospheric pressure) is transported from the collection hose 206, along the second conduit 274 and through the hose-to-overflow valve 244 to overflow tank 210. The overflow tank 210 is provided in the sealed configuration. At the overflow tank 210, build material separates from air flow and drops from the overflow inlet area into the overflow tank 210. Air (and any residual build material) continues along the fourth conduit 278 and through the overflow-to-pump valve 248 towards the pump 204, which is at a reduced pressure.

To help limit unfused build material traveling through the overflow inlet area of the overflow tank 210 into the fourth conduit 278 towards the pump 204, the overflow inlet area can include an overflow build material trap 218a (e.g. a powder trap).

The overflow build material trap 218a is arranged to collect build material from the second conduit 274 and divert the build material (e.g. powder) into the overflow tank 210. Thus, the overflow build material trap 218a helps limit build material conveying past the overflow inlet area of the overflow tank 210 and entering the fourth conduit 278 via the overflow tank vacuum port 279 to travel towards the pump 204.

The overflow build material trap 218a may include a filter (e.g. a mesh), which collects build material transported from the overflow tank 210. Thus, the filter separates build material from air flow in the overflow inlet area. Holes in the filter are small enough to limit the passage of at least 95% of build material but allow relatively free flow of air through the filter. Holes in the filter may be small enough to limit the passage of at least 99% of build material, whilst still allowing relatively free flow of air through the filter. Build material collected by the filter may drop from the overflow inlet area into the overflow tank 210.

Recoverable unfused build material in the trolley 102 (or container) can be transported to the recovered build material tank 208 in a similar way. To transport the unfused build material from the trolley 102 to the recovered build material tank 208, the hose-to-RBMT valve 242 in the first conduit 272 between the collection hose 206 and the recovered build material tank 208 and the RBMT-to-pump valve 246 in the third conduit 276 between the pump 204 and the recovered build material tank 208 can be opened electronically by the controller 295 as described above. When the pump is active, a differential pressure is provided from the pump to the collection hose 206. That is, a pressure at the pump 204 is lower than a pressure at the collection hose 206. The differential pressure enables build material from the trolley 102 (or container) to be transported to the recovered build material tank 208. Build material (and air) in proximity with an end of the collection hose 206 (at approximately atmospheric pressure) is transported from the collection hose 206, along the first conduit 272 and through the hose-to-RBMT valve 242 to the recovered build material tank 208. At the recovered build material tank 208, build material separates from air flow and drops from the RBMT inlet area into the recovered build material tank 208. Air (and any residual build material) continues along the third conduit 276 and through the RBMT-to-pump valve 246 towards the pump 204, which is at reduced pressure relative to atmospheric pressure.

Each of the recovered build material tank 208, the overflow tank 210, and the mixing tank 213 has a build material trap 218b, 218a and 218c respectively. These build material traps 218a, 218b, 218c perform cyclonic filtration of an incoming fluidised flow of build material and air as schematically illustrated in FIG. 2C. An inlet 296 of the build material trap 218 receives the fluidised flow of build material and the build material is pushed by a centrifugal force created by suction of the pump 204 to an outer wall 297 of the build material trap 218. In one example, the outer wall 297 of the build material trap 218 has a circular cross-section and the incoming build material migrates via a cyclonic action to the outer wall 297 of the build material trap 218 until the incoming air reaches an exit below, whereupon the build material particles drop down into a vacuum sealed recipient 299 in the build material trap 218. Thus the build material trap 218 separates a fluidised flow of build material into a powder component, which is deposited in the associated tank and an air component, which is sucked towards the pump 204 via an air outlet 298 in the build material trap 218 providing an interface to the pump 204. A filter (not shown) may be provided in the air outlet 298 of the build material trap 218 to reduce the likelihood of any remaining build material reaching the pump 204 in the separated air flow. The build material trap 218 provides efficient powder separation via its geometry that promotes formation of a cyclone within the build material trap in use. It offers transportation of build material in an air flow and storage of the powder in a tank, whilst diverting an air flow out of the tank towards the pump 204. The build material trap provides a filter to capture residual powder in an air flow emerging from the cyclone to prevent it from reaching the pump 204. The build material trap 218 is one example of a build material filter having a function of separating an air from a build material flow at a corresponding tank inlet area. In other examples, the air flow is separated from the fluidised build material upon arrival at a destination tank using a filter other than a cyclonic filter. For example, a diffusion filter may be used.

Returning to FIG. 2A, the RBMT inlet area of the recovered build material tank 208 may also include the RBMT build material trap 218b (e.g. a powder trap) or another type of RBMT build material filter to separate build material and air from an incoming fluidised flow of build material. The RBMT build material trap 218b operates in the same or a similar way as the overflow build material trap 218a in the overflow tank 210, to help collect and divert build material into the recovered build material tank 208 to help limit build material from traveling through the third conduit 276 towards the pump 204.

When collecting material from the trolley 102 via the collection hose 206, as described above, a user can move the end of the collection hose 206 around the working area 203 including the trolley 102 to collect as much build material from the trolley 102 as possible.

The recovered build material tank 208 is also connected via a fifth conduit (overflow-to-RBMT conduit) 280 of the conduit network. An overflow tank port in the form of an overflow tank inlet port 281 may also be provided at an end of the fifth conduit 280. Build material from the overflow tank 210 can be transported through the fifth conduit 280 and overflow tank inlet port 281 into the recovered build material tank 208.

The fifth conduit 280 between the recovered build material tank 208 and the overflow tank inlet port 281 includes an overflow-to-RBMT valve 250 in the path leading to the RBMT build material trap. In the event that the recovered build material tank 208 needs to be refilled with recovered build material, the overflow-to-RBMT valve 250 in the fifth conduit 280 between the recovered build material tank 208 and the overflow tank 210 can be opened, along with the RBMT-to-pump valve 246 in the third conduit 276 between the recovered build material tank 208 and the pump 204. Each of the valves can be opened electronically by the controller 295, as described above. When the pump is active, a differential pressure is provided from the pump to the overflow tank 210. That is, a pressure at the pump 204 is lower than a pressure at the overflow tank 210. In this example, the overflow tank 210 is provided in an unsealed configuration and includes an air inlet (not shown) open to atmosphere to maintain approximately atmospheric pressure within the overflow tank 210. The differential pressure enables build material from the overflow tank 210 to be transported to the recovered build material tank 208. Air flows into the overflow tank 210 through the air inlet. Build material (and air) in the overflow tank is transported from the overflow tank 210, along the fifth conduit 280 and through the overflow-to-RBMT valve 250 to the recovered build material tank 208. At the recovered build material tank 208, build material separates from air flow and drops from the RBMT inlet area into the recovered build material tank 208. Air (and any residual build material) continues along the third conduit 276 and through the RBMT-to-pump valve 246 towards the pump 204, which is at a reduced pressure.

The material management station circuit 200 also includes a mixing tank 212. The mixing tank 212 can be used to mix recovered build material from the recovered build material tank 208 with fresh build material from a fresh build material supply tank 214a or 214b, ready to be used in a 3D printing process.

Although two fresh build material supply tanks 214a, 214b are shown in this example, in other examples, one or more fresh build material supply tanks 214a, 214b may be used. More fresh build material supply tanks 214a, 214b may be used when appropriate.

Each fresh build material supply tank 214a, 214b is connected to the mixing tank 212 via a sixth conduit (a fresh build material conduit) 282 of the conduit network and a fresh build material supply tank port 283a, 283b. The fresh build material supply tank port 283a, 283b is to output build material from the respective fresh build material supply tank 214a, 214b. Each fresh build material supply tank 214a, 214b has an associated material supply tank cartridge-to-mixer valve 252a, 252b in the sixth conduit 282 between the respective fresh build material supply tank 214a, 214b and the mixing tank 212. Each fresh build material supply tank 214a, 214b also includes an air inlet valve whereby to ensure air can enter the fresh build material supply tanks 214a, 214b to maintain air pressure within the fresh build material supply tanks 214a, 214b at approximately atmospheric pressure.

The mixing tank 212 is connected via a seventh conduit (pump-to-mixer conduit) 284 of the conduit network to the pump 204. The seventh conduit 284 between the mixing tank 212 and the pump 204 includes a mixer-to-pump valve 254, which may be opened or closed to open and close the passage through the seventh conduit 284.

To transport fresh build material from the fresh build material supply tank 214a or 214b to the mixing tank 212, the material supply tank cartridge-to-mixer valve 252a or 252b and the mixer-to-pump valve 254 in the seventh conduit 284 between the mixing tank 212 and the pump 204 are opened. Each of the valves can be opened electronically by the controller 295, as described above. When the pump 204 is active, a differential pressure is provided from the pump 204 to the fresh build material supply tank 214a or 214b. That is, a pressure at the pump 204 is lower than a pressure at the fresh build material supply tank 214a or 214b. The differential pressure enables build material from the fresh build material supply tank 214a or 214b to be transported to the mixing tank 212. Build material (and air) in the fresh build material supply tank 214a or 214b is transported from the fresh build material supply tank 214a or 214b, along the sixth conduit 282 and through the cartridge-to-mixer valve 252a or 252b to the mixing tank 212. At the mixing tank 212, build material separates from air flow and drops from the mixer inlet area into the mixing tank 212. Air (and any residual build material) continues along the seventh conduit 284 and through the mixer-to-pump valve 254 towards the pump 204, which is at a reduced pressure.

The mixer inlet area of the mixing tank 212 can also include a mixer build material trap 218c (e.g. a powder trap) or any type of mixer build material filter to separate an air flow from a build material flow, which operates in the same or similar manner to as the overflow build material trap 218a and the RBMT build material trap 218b. The mixer build material trap 218c helps to collect and divert build material into the mixing tank 212, and help limit the build material from travelling through the seventh conduit 284 towards the pump 204.

The mixing tank 212 is also connected to the recovered build material tank 208 via an eighth conduit (RBMT-to-mixer conduit) 286 of the conduit network and a ninth conduit 288 of the conduit network extending sequentially from the recovered build material tank 208 to the mixing tank 212. The ninth conduit 288 may be part of the RBMT-to-mixer conduit 286.

A sieve 216 may, in some examples, be located in the RBMT to mixer conduit 286 or between the eighth and ninth conduits 286 and 288 between the recovered build material tank 208 and the mixing tank 212. The sieve 216 may be used to separate agglomerates and larger parts of material from the recycled or recovered build material that is transported from the recovered build material tank 208. Often, agglomerates and larger parts of material are not suitable for recycling in a further 3D printing process, so the sieve may be used to remove these parts from the build material. The sieve 216 includes an air inlet (not shown) to ensure air can enter the sieve 216 to maintain air pressure within the sieve 216 at approximately atmospheric pressure. In some examples, the RBMT-to-mixer conduit 286 may not be connected to a build material outlet of the recovered build material tank 208. In other examples a conduit connecting an outlet of the recovered build material tank 208 to a build material inlet in the mixer build material trap 218c of the mixing tank 212 may form a closed circuit.

A RBMT-to-sieve valve 256 is located in the eighth conduit 286 between the recovered build material tank 208 and the sieve 216, and a sieve-to-mixer valve 258 is located in the ninth conduit 288 between the sieve 216 and the mixing tank 212. The RBMT-to-sieve valve 256 and sieve-to-mixer valve 258 may be opened or closed to open and close the passages through the eighth and ninth conduits 286, 288 between the recovered build material tank 208 and the mixing tank 212. The valves may be opened or closed electronically by the controller 295.

To transport build material from the recovered build material tank 208 to the mixing tank 212 both the RBMT-to-sieve valve 256 and the sieve-to-mixer valve 258 in the eighth and ninth conduits 286, 288 between the recovered build material tank 208 and the mixing tank 212 can be opened as well as the mixer-to-pump valve 254 in the seventh conduit 284 that connects the mixing tank 212 to the pump 204. Build material in the recovered build material tank 208 may drop down into the sieve 216 through the eighth conduit 286 by gravity, for example. When the pump 204 is active, a differential pressure is provided from the pump 204 to the sieve 216. That is, a pressure at the pump 204 is lower than a pressure at the sieve 216. The differential pressure enables build material from the recovered build material tank 208 to be transported to the sieve 216 by gravity and to the mixing tank 212 by suction. Build material in the recovered build material tank 208 is transported through the RBMT material outlet, along the eighth conduit 286 and through the RBMT-to-sieve valve 256 to the sieve 216. Build material (and air) in the sieve 216 is transported from the sieve 216, along the ninth conduit 288 and through the sieve-to-mixer valve 258 to the mixing tank 212. At the mixing tank 212, build material separates from air flow and drops from the mixer inlet area into the mixing tank 212. Air (and any residual build material) continues along the seventh conduit 284 and through the mixer-to-pump valve 254 towards the pump 204, which is at a reduced (negative) pressure.

A currently selected ratio of recycled build material from the recovered build material tank 208 and fresh build material from the fresh build material supply tank 214a or 214b can be transported to the mixing tank 212 as described above. The ratio of fresh build material to recovered build material may be any selected ratio. The ratio may depend on the type of build material and/or the type of additive manufacturing process. In a selective laser sintering process the ratio could be, for example 50% fresh to 50% recovered build material. In one example of a printhead cartridge 3D printing process, the ratio may be 80% recovered to 20% fresh build material. For some build materials 100% fresh build material may be used, but for other build materials up to 100% recovered build material may be used. The fresh build material and the recovered build material can be mixed together within the mixing tank 212 using, for example, a rotating mixing blade 213.

Once the fresh build material and the recovered build material are sufficiently mixed, the mixed build material can be transported from the mixing tank 212 through a mixer-to-trolley valve 260, a tenth conduit (mixer-to-trolley conduit) 290 of the conduit network, a working area port in the form of a working area outlet port 291, to the working area 203 and into the trolley 102. Build material from the mixing tank 212 can pass through the working area outlet port 291 into the working area 203. The trolley 102 (or container) can be located substantially beneath the mixing tank 212 so that gravity can aid the transport of mixed build material from the mixing tank 212, through the mixer-to-trolley valve 260, the tenth conduit 290, the working area outlet port 291 and the working area 203 to the trolley 102.

Once the trolley 102 is filled with enough build material for a given 3D print run, the trolley 102 can be returned to the 3D printer 104. An appropriate quantity of build material to fill the trolley 102 for a print job may be controlled by the controller 295 of the material management station 106 based on the material management station 106 sensing how much build material is in the trolley when the trolley is docked in the material management station 106 at the beginning of a trolley fill workflow. The controller may then fill the trolley with a particular quantity (dose) of build material requested by a user for a particular print job intended by the user. The dosing is achieved by using a fill level sensor (not shown) such as a load cell in the mixing tank 212 to output a fill level value indicative of an amount of non-fused build material in the mixing tank. The fill level sensor can be one or more load cells, or any other type of sensor such as a laser-based sensor, a microwave sensor, a radar, a sonar, a capacitive sensor, etc. When the fill level sensor is a load cell, the fill level value can be an electrical signal indicative of a mass of the non-fused build material in the storage container.

A number of different workflows may be implemented in the material management station 106. These workflows are managed by the user, but some level of automation may be provided by a data processor on the material management station 106. For example, the user may select a workflow from a digital display on the material management station 106. For users having one material management station 106 and one printer 104 an example workflow cycle may be filling the trolley 102, followed by printing a 3D object, followed by unpacking the object from a build volume in the material management station 106 followed by a subsequent print operation and a corresponding unpacking of the build volume and so on. However, the material management station 106 may serve two or more printers so that successive unpacking and trolley filling operations may be performed by the material management station 106. The user may also choose to perform the trolley filling, printing and unpacking functions in a random order.

For each of the workflow operations, a user interface of the material management station 106 may guide the user to undertake particular manual operations that may be performed as part of the workflow operation. For example, to perform an unpack operation, the user interface may instruct the user to move the collection hose 206 around the collection area 203 as described previously. In addition, the material management station 106 can automatically initiate other functions of the workflow operation. For example, to perform the unpack operation, the material management station 106 can automatically operate the pump 204 whilst the user moves the collection hose 206 around the collection area 203 to recover build material from the trolley 102. Any workflow operations the material management station 106 can perform fully automatically may be signalled to the user through the user interface without requiring user confirmation to proceed. If the workflow operation could present a potential safety risk, the otherwise fully automatic workflow operation may require user confirmation to proceed.

For example, to load the trolley 102 with build material, the user sets this workflow operation then the material management station 106 automatically launches the different operations required sequentially. The material management station 106 is controlled to send build material from the recovered build material tank 208 to the mixing tank 212. The material management station 106 is further controlled to send fresh build material from at least one of the fresh build material supply tanks 214a, 214b to the mixing tank 212. The material management station 106 is subsequently controlled to blend the mixture in the mixing tank 212. The mixed build material in the mixing tank 212 can then be discharged to the trolley 102. In an example, this workflow operation is completed as a batch process, and so the cycle may be continuously repeated to completely fill the trolley 102.

In some processes, a small portion (e.g. 1%) of build material can pass through the build material traps 218a, 218b, 218c (e.g. the powder traps) and can travel towards the pump 204.

An additional RBMT build material trap 220 (e.g. a powder trap) may, in some examples, be located in an eleventh conduit (pump feed conduit) 292 of the conduit network that connects each of the third, fourth and seventh conduits 276, 278 and 284 to the pump 204. The additional RBMT build material trap 220 is connected to the RBMT inlet area. The additional RBMT build material trap 220 collects build material that may have passed through any of the overflow build material trap 218a, RBMT build material trap 218b or mixer build material trap 218c to help limit it from reaching the pump 204. Build material collected in the additional RBMT build material trap 220 can be transported into the recovered build material tank 208 by opening a trap-to-RBMT valve 262. The trap-to-RBMT valve 262 may be opened electronically by the controller 295. The RBMT build material trap 220 may operate in the same or similar way to each of the overflow, RBMT, and mixer build material traps 218a, 218b and 218c. Build material can be transported from the RBMT build material trap 220 to the recovered build material tank 208 by gravity,

A pump filter 222 may also be located in a twelfth conduit 294 of the conduit network adjacent the pump 204. This pump filter 222 helps to collect any build material that may have passed through any of the overflow build material trap 218a, RBMT build material trap 218b or mixer build material trap 218c as well as the additional RBMT build material trap 220. This helps prevent the build material from reaching the pump 204, thereby reducing the likelihood of the function of the pump 204 being impaired, which could happen if large quantities of build material were to reach it.

At any time, when the material management station 106 is to be used to process build material of a different material type, for example of a different material, the material management station circuit 200 can be controlled to implement a purging process to purge substantially all build material of a current material type from the material management station circuit 200 to the overflow tank 210. The fresh build material supply tanks 214a, 214b can be disconnected from the build material management station circuit 200 and stored to limit wastage of fresh building material of the current material type.

In one example, the purging process is carried out when unfused build material in the trolley 102 has already been collected using the collection hose 206 and transported either to the recovered build material tank 208 or to the overflow tank 210, or both. Alternatively, the purge process can include using the collection hose 206 to transport any unfused build material in the trolley 102 to the overflow tank 210, as described previously.

The purge process includes transporting any unfused build material in the recovered build material tank 208 to the overflow tank 210. To transport unfused build material from the recovered build material tank 208 to the overflow tank 210, the RBMT-to-sieve valve 256 and the sieve-to-mixer valve 258 in the eighth and ninth conduits 286, 288 between the recovered build material tank 208 and the mixing tank 212 can be opened as well as the mixer-to-trolley valve 260 in the tenth conduit 290 and the hose-to-overflow valve 244 in the second conduit 274 between the collection hose 206 and the overflow tank 210 and the overflow-to-pump valve 248 in the fourth conduit 278 between the pump 204 and the overflow tank 210. Any build material in the recovered build material tank 208 drops down into the sieve 216 through the eighth conduit 286 by gravity. The collection hose 206 can be connected directly to the tenth conduit 290 before or after any cleaning of the unfused build material in the trolley 102 has been completed. When the pump 204 is active, a differential pressure is provided from the pump 204 to the sieve 216 via the overflow-to-pump valve 248, the overflow tank 210, the hose-to-overflow valve 244, the collection hose 206, the mixer-to-trolley valve 260, the mixing tank 212 and the sieve-to-mixer valve 258. Build material in the recovered material tank 208 is transported to the sieve 216 by gravity via the eighth conduit 286 and the RBMT-to-sieve valve 256. That is, a pressure at the pump 204 is lower than a pressure at the sieve 216. The differential pressure enables build material from the recovered build material tank 208 to be transported to the sieve 216 and on to the overflow tank 210. At the overflow tank, build material separates from air flow and drops from the overflow inlet area into the overflow tank 210. Air (and any residual build material) continues along the fourth conduit 278 and through the overflow-to-pump valve 248 towards the pump 204, which is at a reduced pressure. It can be seen that any unfused build material in the sieve 216, the mixing tank 212 or in any of the eighth conduit 286, the ninth conduit 288, the tenth conduit 290 or the second conduit 274 may also be transported to the overflow tank 210. In this way, substantially all unfused build material in the material management station circuit 200 can be transported to the overflow tank 210.

Alternatively, the unfused build material in the recovered build material tank 208 can be transported to the trolley 102 as described previously. Subsequently, the unfused build material in the trolley 102 can be transported to the overflow tank 210, also as described previously. Thus, an alternative way to transport unfused build material from the recovered build material tank 208 to the overflow tank 210 can be provided without directly connecting the collection hose 206 to the tenth conduit 290.

The purge process can also include one or more further purging process elements where a sacrificial material is transported through any part of the conduit network of the material management station circuit 200 which may still contain at least an amount of unfused build material of a current material type. The sacrificial material can act to dislodge at least some of the current build material remaining in the material management station circuit 200. The sacrificial material in one example may be the build material of the different build material type to be subsequently used in the material management station 106. The sacrificial material may alternatively be an inert material (e.g. silica) which is not a build material. In this way, any small amount of sacrificial material remaining in the material management station 106 at the end of the purging process is unlikely to interfere with the further operation of the material management station 106.

After the purge process is completed, and substantially all the unfused build material in the material management station circuit 200 is in the overflow tank 210, the overflow tank 210 can then be removed from the material management station 106, for example for storage or disposal and a further overflow tank (not shown) can be connected to the material management station 106. The further overflow tank can be empty or the further overflow tank can contain build material previously purged from the (or another) material management station 106.

The purge process can be performed in response to a user input, or automatically. Where purging is performed automatically, the material management station circuit 200 can be controlled to implement the purging process when a trolley 102 containing a different material is slotted into the docking position 107 in the material management station 106. In this example, a material type is electronically recorded on a memory chip of the trolley 102 (or other container). The memory chip is readable by the processing circuitry of the material management station 106 to determine the material type of the material in the trolley 102 (or other container). Alternatively or additionally, the material management station circuit 200 can be controlled to implement the purging process when one or more fresh build material supply tanks 214a, 214b containing a different material type are connected to the material management station circuit 200. In this example, a material type is electronically recorded on a memory chip of the fresh build material supply tanks 214a, 214b. The memory chip is readable by the processing circuitry of the material management station 106 to determine the material type of the material in the fresh build material supply tanks 214a, 214b. In other examples, the material management station circuit 200 can be controlled to implement the purging process when both fresh build material supply tanks 214a, 214b are removed from the material management station circuit 200. It will be appreciated that the material management station 106 may be controlled to provide an indication to a user that the purging process can be performed based on the criteria discussed previously.

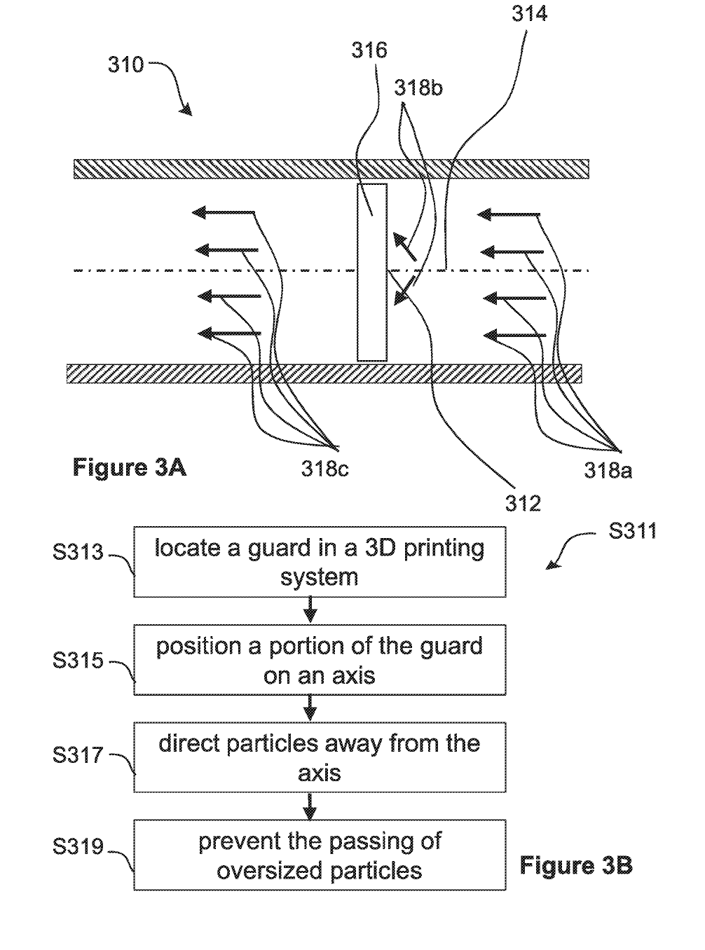

FIG. 3A shows a side view cross-sectional representation of a guard 310 for a 3D printing system to limit a passing of oversized particles of material to downstream of the guard 310. The guard 310 comprises a portion 312 positionable on an axis 314, the axis 314 being parallel to a direction of travel of particles. The guard 310 comprises a guard member 316 to direct particles away from the axis 314. The guard 310 is positionable in the 3D printing system to limit a passing of oversized particles of material to downstream of the guard 310.

Here, the portion 312 comprises a center portion and the axis 314 comprises a central axis.

FIG. 3B shows an example method S311 of using the guard 310 to limit the passing of oversized particles. Here, the method S311 is illustrated in sequential steps S313, S315, S317, S319. Accordingly, the limitation of the passing of oversized particles to downstream in a 3D printing system comprises: positioning a portion of the guard on an axis, the axis being parallel to a direction of travel of particles; and directing particles away from the axis; and limiting the passing of oversized particles of material to downstream of the guard. In use, the guard 310 may be used to limit or limit a passing of oversized particles of material in a 3D printing system. The center portion 312 of the guard 310 may be positioned on the central axis 314; particles may be directed particles away from the central axis 314; and the passing of oversized particles of material to downstream of the guard 310 may be limited. The guard 310 may be positioned in a 3D printing system, such as by insertion therein. It will be appreciated that the guard 310 is positionable in the 3D printing system 100 of FIG. 1A or material management station circuit 200 of FIG. 2. For example, the guard 310 may be inserted into the collection hose 206 of the material management station circuit 200 of FIG. 2. Accordingly, the guard 310 may limit the passage of oversized particles further into the material management station circuit 200. The oversized particles may comprise an agglomeration of smaller particles, such as an agglomerate of build material. Oversized may relate to a dimension of particle or particles considered too large for further passage beyond the guard 310. For example, the guard 310 may be useful in limiting particles too large for recycling or further processing in a build material management system, such as limiting the passing of powder stones, fused clumps or other aggregations or conglomerations of powder. In at least some examples, limiting the passing of oversized particles may comprise preventing the passing of oversized particles.

An indication of particle flow, in use, through the guard 310 is provided sequentially by the respective groups of arrows 318a, 318b, 318c in FIG. 3. Diverting particles away from the central axis 314 may assist in mitigating against overloading, clogging or excessive deformation of the center portion 312 of the guard 310. The parallel direction of the axis relative to the travel of the particles may be taken at the position of the guard, indicative of a general direction of the particles at the guard, such as through the guard. It will be appreciated that the direction of travelling particles, such as passing powder in a flow, need not be in a linear direction. For example_{;} in some examples the guard may not be positioned in a conduit. The guard may be positioned at a partition between two chambers; or between a chamber and a conduit or inlet or outlet.

Referring to FIG. 4, there is shown a partial cross-section of a guard 410 positionable in a 3D printing system to limit a passing of oversized particles of material to downstream of the guard 410. The guard 410 of FIG. 4 comprises similar features to the guard 310 of FIG. 3, incremented by 100. For example, the guard 410 comprises a portion 412 aligned with an axis 414, the axis 414 being parallel to a general direction of flow of particles through the guard 410. The guard member 416 shown in FIG. 4 comprises a leading central portion 420 positionable at the central axis 414 to divert particles outwards away from the central axis 414 towards an outer portion 422 of the guard member, the leading central portion 420 being a foremost portion of the guard member 416 in an upstream direction.

As shown in the example of FIG. 4, the guard member 416 comprises a conical form, the conical form having an apex 424 and the apex 424 is positionable at the central axis 414 pointing upstream such that the apex 424 is the leading central portion 420. Here, the guard member 416 comprises a filter 426. The filter 426 comprises a mesh with a maximum aperture size of 2 mm or less to limit the passing of oversized particles greater than 2 mm in diameter. The maximum aperture size of the filter may be selected according to a definition or classification of oversized particles, such as according to an intended use of the guard. It will be appreciated that the classification of oversized particles may vary in different applications, such as for different 3D printing systems. The oversized particles may comprise fused, partially fused or otherwise aggregated powder, such as powder stones, fused clumps or other conglomerations of powder. In some examples, the maximum aperture size of the filter is 1.5 mm; 1.0 mm: 0.5 mm respectively. In some examples, the guard member 416 functions as a minifying element: in use, in addition to trapping the oversized particles, flow pushes oversized particles against the filter 426 such that particles are cut, broken or abraded by the filter 426 until the oversized particles are reduced in size sufficiently to fit through the maximum aperture of the filter 426 and pass downstream of the guard 410. In some examples, the size of aperture is selected according to one or more of: downstream processing requirements; build material; and flow requirements. The size and shape of aperture may be selected to provide an optimal flow whilst still limiting the passing of oversized particles. For example, the aperture size may be as large as permissible, being at or just below a threshold for particles to be considered oversized, such as to enable a maximum flow rate. In other examples, the maximum aperture size may be selected to be significantly less than the threshold size of oversized particles.

The leading central portion 420 of the guard member 416 may assist in distributing load towards the outer portion 422 such that the leading central portion is less susceptible to clogging or deformation. The guard member 416 shown here is non-planar, the conical form defining a dome with a central projection or protrusion in the upstream direction.

The provision of a leading central portion 420 may assist in reducing deformation of the guard member 416, such as by increasing the stiffness of the guard member 416, particularly compared to a flat or planar guard member with no such leading central portion 420. The guard member 416 here has an increased surface area, such as compared to a flat or planar guard member with no leading central portion 420. The example guard member 416 of FIG. 4 comprises a greater surface area than described by a profile of the guard 410 perpendicular to the direction of flow. For example, where the profile of the guard member 416 perpendicular to the direction of flow is a circular profile, such as in FIG. 4 for insertion in a circular passage, such as the collection hose 206 of FIG. 2, the comparatively large surface area of the guard member 416 relative to the circular profile may allow an increased flow rate through the guard 410, such as compared to a similar, planar circular guard member. As shown here, the non-planar form of the guard member 416 provides a relatively large total area of apertures through the guard 410. The non-planar form of the guard member 416 provides an increased total number of apertures—again, such as compared to an alternative planar guard member perpendicular to the flow. Providing an increased total number of apertures may decrease a possibility or likelihood of blockage of the guard. Providing an increased total number of apertures may provide less impedance to flow, such as to allow higher flow rates. Providing an increased number of apertures may allow more sufficient flow in the event of partial blockage, such as of some of the apertures.

It will be appreciated that the example guard member 416 shown in FIG. 4 is generally rotationally symmetrical. Here, the guard has a generally uniform cross-section around its entire rotational profile about the central axis 414, notwithstanding any micro structure of the filter 426.

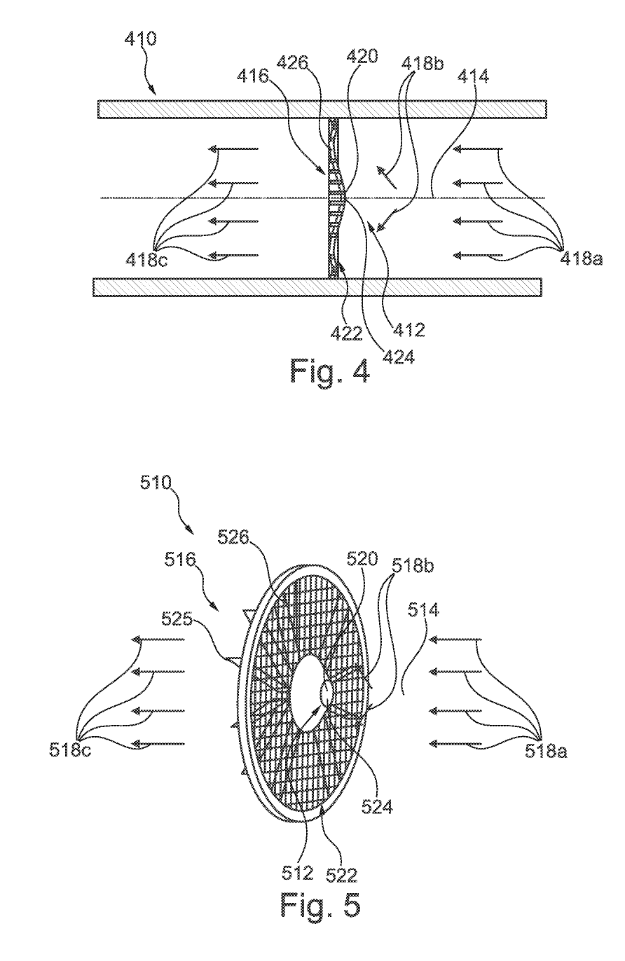

Referring to FIG. 5, there is shown a guard 510 positionable in a 3D printing system to limit a passing of oversized particles of material to downstream of the guard 510. The guard 510 of FIG. 5 comprises similar features to the guard 410 of FIG. 4, incremented by 100. For example, the guard 510 comprises a portion 512 positionable on an axis 514, the axis 514 being parallel to a general direction of flow of particles through the guard 510. The guard 510 comprises a guard member 516 that is rotatable about the axis 514 to direct particles centrifugally outwards away from the axis 514.

In the example shown in FIG. 5, the guard 510 comprises a drive member 525 to rotate the guard member 516 about the central axis 514. As shown here, the drive member 525 comprises a fan element arranged to be driven by a flow through the guard 510 to rotate the guard member 516 when there is flow through the guard 510. Accordingly, no additional drive is required in this example, such as a powered drive using a motor or other propulsion. In use, the drive member 525 is activated by flow through the guard 510, such as associated with the activation of a vacuum or underpressure source upstream of the guard 510.

The guard member 516 comprises a filter 526, with the filter 526 of FIG. 5 being generally planar. The leading central portion 520 shown here comprises an apex 524 and diverts particles towards the filter 526 and does not allow the passage of particles or flow through the leading central portion 520. It will be appreciated that the leading central portion 520 may be used to mount the guard member 516 comprising the filter 526 to the drive member 525 such that the guard member 516 with filter 526 is rotatable with the drive member 525. In the example shown, the guard member 516 is mounted upstream of the drive member 525. Accordingly, the guard member 516 protects the drive member 525, such as to limit damage to a fan blade that may otherwise be associated with contact between a fan blade and an oversized particle. In other examples, the guard member 516 may be mounted downstream of the drive member 525: for example, where it is desired to utilize a fan blade to pre-treat, abrade or cut an oversized particle prior to contact with the filter 526.

Here the guard member 516 functions as a minifying element that may assist in diminishing oversized particles. The rotation of the guard member 516 comprising the filter 526 results in a velocity of the minifying element perpendicular to the direction of flow of the particles. Such movement of the filter 526 relative to the flow of particles may assist in diminishing the particles, such as by abrasion, cutting, breaking, or the like or otherwise mechanically shrinking the oversized particles. It will be appreciated that an absolute velocity increases with radius such that the outer portion 522 of the guard member 516 has a greater velocity than the leading central portion 520. Accordingly, the filter 526 at the outer portion 522 may provide a more effective diminishing of oversized particles, such as associated with a higher velocity abrasion. Directing oversized particles outwards, away from the central axis 514 may assist in the diminishment of the oversized particles, by diverting the oversized particles to a more effective portion of the filter 526 associated with the higher velocity.

It will be appreciated that in some examples the guard member may comprise a minifying element without the minifying element comprising a filter. For example, the minifying element may comprise a cutter, grinder or abrasive element for mechanically breaking up oversized particles. In some examples, the guard may comprise an additional filter; or may comprise no filter.

In some examples, in use, a method of limiting a passing of oversized particles of material in a 3D printing system may comprise: positioning the guard in a 3D printing system; diminishing a size of an oversized particle contacting a guard member of the guard; and limiting the passing of oversized particles of material to downstream of the guard. It will also be appreciated that in some examples the minifying element may not rotate about a central axis. For instance, in some examples the minifying element may rotate about an axis perpendicular to a direction of flow or travelling particles; or the minifying element may not rotate, such as where a guard member may oscillate or vibrate to abrade or otherwise mechanically shrink oversized particles. The oversized particles may be sufficiently reduced in size so as to allow their further travel and optional further processing or recycling downstream of the guard.

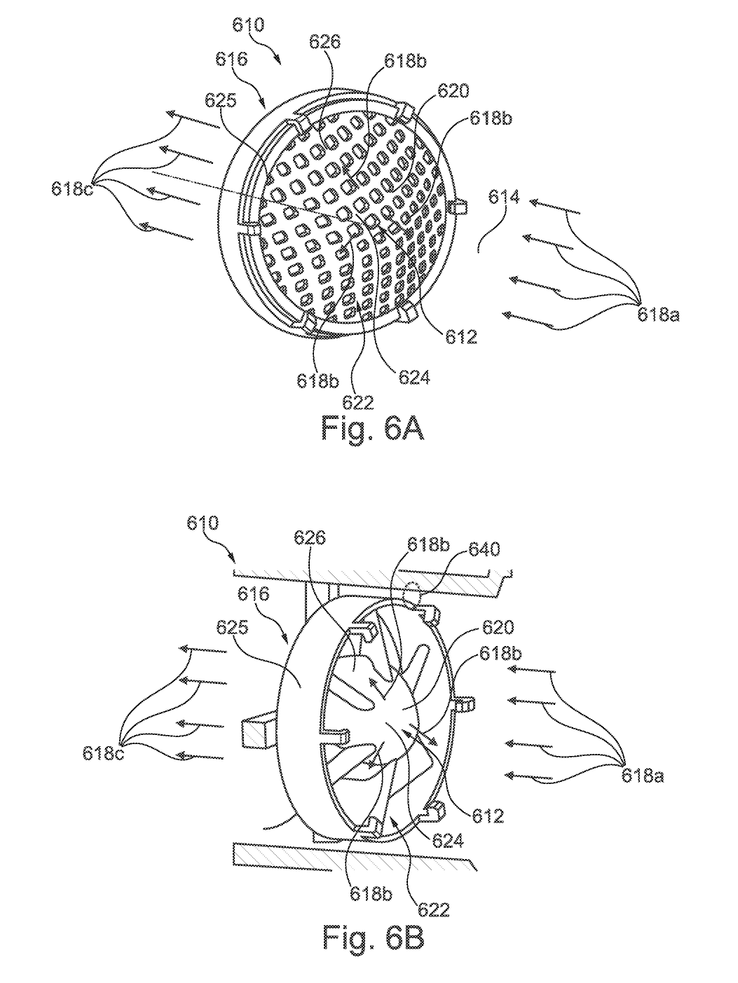

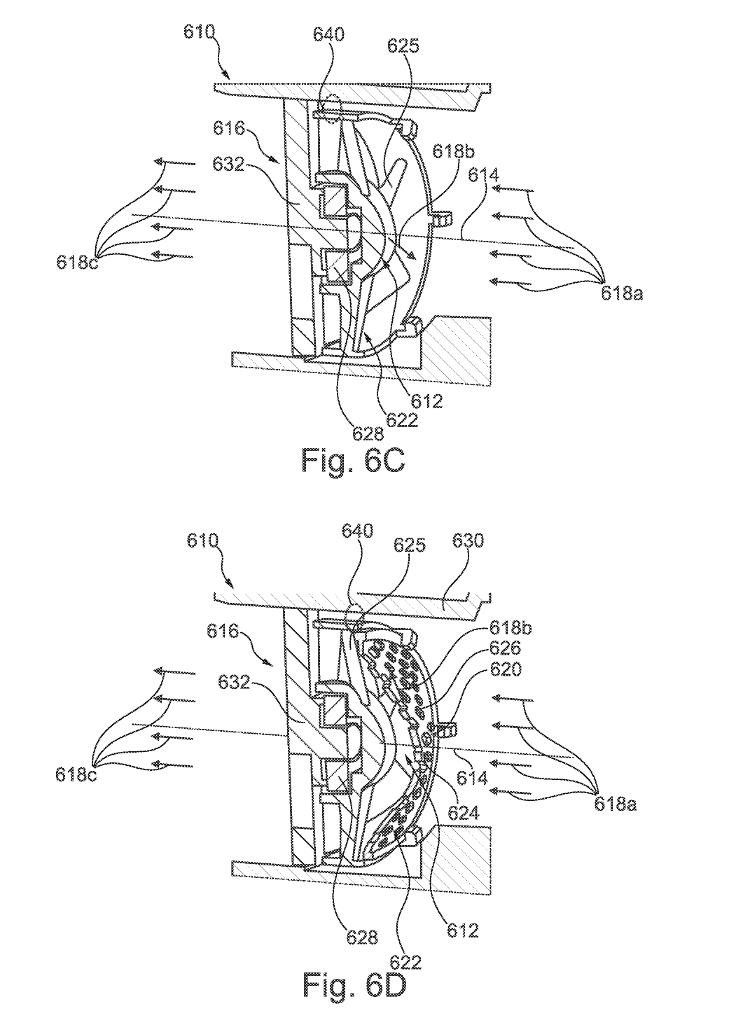

Referring to FIGS. 6A, 6B, 6C and 6D, there is shown a guard 610 positionable in a 3D printing system to limit a passing of oversized particles of material to downstream of the guard 610. The guard 610 of FIGS. 6A-6D comprises similar features to the guard 510 of FIG. 5, incremented by 100. For example, the guard 610 comprises a center portion 612 positionable on a central axis 614, the central axis 614 being parallel to a general direction of flow of particles through the guard 610. The guard 610 comprises a guard member 616 that is rotatable about the central axis 614 to direct particles centrifugally outwards away from the central axis 614.

As shown in FIGS. 6A-6D, the guard member 616 is mounted in a 3D printer build material passage 630, such as the collection hose 206 of FIG. 2. Here, the guard member 616 is positioned in the passage 630 via a mounting member 632. The guard member 616 comprising the filter 626 is connected to the mounting member 632 via the drive member 625 and a bearing 628 for the drive member 625, as can be seen in FIGS. 6B and 60, where the filter 626 is not shown for clarity. The filter 626 is grounded. Here, the mounting member 632 provides a grounding for the guard member 616, the mounting member 632 being a conductor mechanically connected to the guard member 616. In the example shown here, the filter 626 is a stainless steel mesh. In the absence of grounding, there may otherwise be a possibility of static build-up so as to impede a functionality of the filter 626. Grounding the guard 610 provides a discharge path for electrostatic charge caused by transport of the particles through the guard 610. Grounding the filter 626 to the passage 630 may help improve the performance of the guard 610 by limiting or reducing particles being attracted to, sticking to or otherwise adhering to the guard member 616. It will be appreciated that the passage 630 may provide indirect grounding: for example, where the passage 630 is comprised in the collection hose 206 of FIG. 2 and the collection hose 206 is grounded to a housing.

The filter 626 shown here is a woven stainless steel mesh with maximum aperture size in the range 1.0 mm to 1.5 mm. The filter 626 comprises a conical form, with an apex 624 at a leading central portion 620, generated by inelastically deforming a flat woven wire thread mesh. The material of the filter 626 may be resistant to, or repellent of, the particle or particle material. For example, the stainless steel surface of the mesh may be resistive to adherence by at least some 3D printer build materials. In alternative examples, other forms and materials of filter may be provided, such as non-woven filters. Similarly, although shown here with square apertures, other example filters may comprise other shapes and sizes of apertures, such as round, oval, linear, or the like.

The guard 610 is mounted in the passage 630 such that a clearance 640 between the guard member 616 and a passage wall is less than or equal to a maximum aperture size of the filter 626. Accordingly the guard 610 is mounted in the passage 630 such that oversized particles cannot circumvent or bypass the guard 610 by passing through the clearance 640 between the guard member 616 and the passage 630. In use, the rotation of the guard member 616 may diminish oversized particles between the guard member 616 and the passage 630, such as by abrasion of oversized particles between an outer diameter of the guard member 616 and the inner wall of the passage 630.

In use, the guard may limit the passage of oversize particles to downstream of the guard, such as towards a vacuum source or particle collector. The guard may limit the passage of oversize particles in the event of reduced rotation or non-rotation of the guard. For example, the guard may comprise no apertures larger than an oversized particle such that, upon vacuum start-up, no oversized particles can pass through the guard before the rotatable guard member reaches an operational velocity for actively diminishing the oversized particles.

It will be appreciated that although shown here positioned directly on the central axis, in some examples the leading portion of the guard element may be positioned with the apex at the central axis, but not directly on the central axis. For example, the apex may be positioned at the central axis slightly offset from the axis such that the apex is not directly on the central axis. Similarly, although the central axis 614 of the guard 610 shown here is collinear with a central axis of the passage 630, in some examples the guard may be offset such that the guard central axis is not collinear with the passage central axis.

As shown here, the guard is mounted in the passage distal from an inlet to the conduit. It will be appreciated that the guard may be mounted sufficiently distal to the conduit inlet, such as an inlet of the collection hose 206 of FIG. 2, to limit or mitigate against potential injury associated with an insertion of a small hand or digit into the conduit. The guard may be positioned in the conduit to limit possible contact, in use, between the guard and a body part, particularly where the guard comprises a rotatable guard member. Accordingly, in some examples the guard may be spaced at a greater distance from the conduit inlet than a maximum length of the body part insertable into the conduit. For example, some guards may be spaced at a distance of at least 5 cm; at least 8 cm; at least 10 cm; or at least 15 cm respectively or more from an inlet.

In some examples a stationary safety shield may be located upstream of the guard member. In such examples the guard may be located more proximal to the inlet, wherein the safety shield limits injury associated with an insertion of a body part into the conduit.

In some examples, the guard may be accessibly positioned in the system. For example, the guard may be accessibly mounted in the system so as to allow at least one of: inspection, maintenance, cleaning and replacement. In some examples, the guard may be removably mounted.

Example 1 may comprise a guard for a 3D printing system, the guard comprising:
a portion aligned with an axis, the axis being parallel to a direction of travel of particles; and
a guard member to direct particles away from the axis;
wherein the guard is positionable in the 3D printing system to limit a passing of oversized particles of material to downstream of the guard.

Example 2 may comprise the guard of Example 1 wherein the guard member is rotatable about the axis to direct particles centrifugally outwards away from the axis.

Example 3 may comprise the guard of Example 1 or Example 2, or some other example herein, wherein the guard member is rotatable about the axis and the guard member comprises a minifying element to mechanically diminish an oversized particle contacting the guard member.

Example 4 may comprise the guard of any one of Examples 1 to 3, or some other example herein, wherein the guard comprises a drive member to rotate the guard member about the axis and the drive member comprises a fan element to be driven by a flow through the guard to rotate the guard member when there is flow through the guard.

Example 5 may comprise the guard of any one of Examples 1 to 4, or some other example herein, wherein the guard member comprises a leading central portion positionable at the axis to divert particles outwards away from the axis towards an outer portion of the guard member, the leading central portion being a foremost portion of the guard member in an upstream direction.

Example 6 may comprise the guard of any one of Examples 1 to 5, or some other example herein, wherein the guard member comprises a conical form, the conical form having an apex and the apex being positionable at the axis pointing upstream such that the apex is the leading central portion.

Example 7 may comprise the guard of any one of Examples 1 to 6, or some other example herein, wherein the guard member comprises a filter.

Example 8 may comprise the guard of Example 7, or some other example herein, wherein the filter comprises a mesh with a maximum aperture size of 2 mm or less to limit the passing of oversized particles greater than 2 mm in diameter.

Example 9 may comprise a 3D printing system comprising the guard of any one of Examples 1 to 8, or some other example herein.

Example 10 may comprise a method of limiting a passing of oversized particles of material in a 3D printing system, the method comprising:
positioning a guard in a 3D printing system;
aligning a portion of the guard with an axis parallel to a direction of travel of particles; and
directing particles away from the axis.

Example 11 may comprise the method of Example 10, or some other example herein, comprising rotating the guard member about the axis.

Example 12 may comprise the method of Example 10 or Example 11, or some other example herein, comprising positioning a leading central portion of the guard member at the axis to divert particles outwards away from the axis towards an outer portion of the guard member, the leading central portion being a foremost portion of the guard member in an upstream direction.

Example 13 may comprise a 3D printer material guard wherein the guard is mountable in a 3D printing system to limit a passing of oversized particles of material to downstream of the guard and the guard comprises a guard member selected from:
a guard member comprising a minifying element diminish an oversized particle contacting the guard member; and
a guard member comprising a conical form.

Example 14 may comprise the guard of Example 13, or some other example herein, wherein the guard member comprises both the minifying element and the conical form and the guard member is rotatable about an axis parallel to a direction of travel of particles.

Example 15 may comprise a 3D printing system comprising the guard of Example 13 or Example 14, or some other example herein.

All of the features disclosed in this specification (including any accompanying claims, abstract and drawings) may be combined in any combination, except combinations where at least some of such features are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example of a generic series of equivalent or similar features.

The present teachings are not restricted to the details of any foregoing examples. Any novel combination of the features disclosed in this specification (including any accompanying claims, abstract and drawings) may be envisaged. The claims should not be construed to cover merely the foregoing examples, but also any variants which fall within the scope of the claims.

1. A guard for a 3D printing system, the guard comprising:
a portion aligned with an axis, the axis being parallel to a direction of travel of particles; and
a guard member to direct particles away from the axis;
wherein the guard is positionable in the 3D printing system to limit a passing of oversized particles of material to downstream of the guard.

2. The guard of claim 1 wherein the guard member is rotatable about the axis to direct particles centrifugally outwards away from the axis.

3. The guard of claim 2 wherein the guard member is rotatable about the axis and the guard member comprises a minifying element to mechanically diminish an oversized particle contacting the guard member.

4. The guard of claim 2 wherein the guard comprises a drive member to rotate the guard member about the axis and the drive member comprises a fan element to be driven by a flow through the guard to rotate the guard member when there is flow through the guard.

5. The guard of claim 1 wherein the guard member comprises a leading central portion positionable at the axis to divert particles outwards away from the axis towards an outer portion of the guard member, the leading central portion being a foremost portion of the guard member in an upstream direction.

6. The guard of claim 5 wherein the guard member comprises a conical form, the conical form having an apex and the apex being positionable at the axis pointing upstream such that the apex is the leading central portion. 7 The guard of claim 1 wherein the guard member comprises a filter.

8. The guard of claim 7 wherein the filter comprises a mesh with a maximum aperture size of 2 mm or less to limit the passing of oversized particles greater than 2 mm in diameter.

9. A 3D printing system comprising the guard of claim 1.

10. A method of limiting a passing of oversized particles of material in a 3D printing system, the method comprising:
positioning a guard in a 3D printing system;
aligning a portion of the guard with an axis, the axis being parallel to a direction of travel of particles; and
directing particles away from the axis.

11. The method of claim 10 comprising rotating the guard member about the axis.

12. The method of claim 10 comprising positioning a leading central portion of the guard member at the axis to divert particles outwards away from the axis towards an outer portion of the guard member, the leading central portion being a foremost portion of the guard member in an upstream direction.

13. A 3D printer material guard wherein the guard is mountable in a 3D printing system to limit a passing of oversized particles of material downstream of the guard and the guard comprises a guard member selected from:
(i) a guard member comprising a minifying element to diminish an oversized particle contacting the guard element; and
(ii) a guard member comprising a conical form.

14. The guard of claim 13 wherein the guard member comprises both the minifying element and the conical form; and the guard member is rotatable about an axis parallel to a direction of travel of particles.

15. A 3D printing system comprising the guard of claim 13.
